(19) United States
(12) Patent Application Publication
(10) Pub. No.: US 2023/0103938 A1
(43) Pub. Date: Apr. 6, 2023

(54) Customer Driven Service Development and Integration

(71) Applicant: Mutara, Inc., San Ramon, CA (US)

(72) Inventors: Laurence Karl Grey, San Ramon, CA (US); Brian Mark Sparling, Fremont, CA (US)

(21) Appl. No.: 17/956,678

(22) Filed: Sep. 29, 2022

Related U.S. Application Data
(60) Provisional application No. 63/251,480, filed on Oct. 1, 2021.

(51) Int. Cl. G06F 8/20; G06F 3/04842

(52) U.S. Cl. CPC G06F 8/24; G06F 3/04842

(57) ABSTRACT

Customer driven service development and integration systems and methods are disclosed herein. An example method includes storing an existing application in a data storage system, providing a user interface that allows a user to interact with the existing application, the user interface executing on a computing device or a network of the user, to initiate creating a new application, receiving selections of defined data objects through the user interface, storing the selections as metadata objects associated with the existing application, for inclusion in the new application, determining handling parameters for the defined data objects, including transformations for the defined data objects and changes to values of the defined data objects before, during and after execution of the new application, and combining the defined data objects into the new application.

### CROSS-REFERENCE(S) TO RELATED APPLICATION(S)

This application claims the benefit and priority of U.S. Provisional Application 63/251,480, filed on Oct. 1, 2021, which is hereby incorporated by reference herein in its entirety, including all references cited therein, for all purposes.

### FIELD OF INVENTION

The present technology pertains to systems and methods for new software development and integration platforms. In particular, but not by way of limitation, the present technology provides a Customer Driven Service Development and Integration Platform.

### SUMMARY

In some embodiments the present technology is directed to a computer implemented method for the creation of new application services within an existing application system with minimal coding by using predefined tools in the existing application system, the method comprising: interacting with a user interface of an existing application system associated with a user, stored in one or more data storage systems, and running on the user's computing device or network, to initiate creating a new application service, wherein the one or more data storage systems may store multiple other versions of the existing application system, each version associated with a separate user; selecting relevant defined data objects, stored in one or more database tables or metadata objects associated with the existing application system, for inclusion in the new application service, wherein the values of each defined data object may affect the appearance or function of the new application service; setting how the defined data objects will be handled, including any transformations of the defined data objects and any changes to their values before, during and after the execution of the new application service; combining the defined data objects into a new application service that delivers intended functionality; adding metadata for the new application service into a services module table or metadata object of the one or more database tables or metadata objects, to register the new application service with the existing application system, allowing the new application service to be executed, wherein the services module table or metadata object contains all registered services in the existing application system; and sequestering the existing application system with the new application service from the multiple other versions of the existing application system stored in the one or more data storage systems.

One embodiment includes a method comprising storing an existing application in a data storage system; providing a user interface that allows a user to interact with the existing application, the user interface executing on a computing device or a network of the user, to initiate creating a new application; receiving selections of defined data objects through the user interface; storing the selections as metadata objects associated with the existing application, for inclusion in the new application; determining handling parameters for the defined data objects, including transformations for the defined data objects and changes to values of the defined data objects before, during and after execution of the new application; and combining the defined data objects into the new application.

One embodiment includes a system comprising a data storage system for storing metadata for data objects of an existing application; a services layer comprising service definitions the metadata obtained from the data storage system; a service transformation and mapping component that utilizes the service definitions to produce a new or altered service, program, or application by transformation and mapping of the service definitions; a user experience and interface layer that transforms instructions from the services layer into a user interface, the user experience and interface layer comprising: a form layer that determines how forms displayed to the user are labeled, and what data fields are included in the forms; a step component that obtains multiple forms from the form layer and determines an order by which the multiple forms, and other data objects are displayed to the user, as well as any labels or icons displayed; and a layout component that defines how the multiple forms are displayed and determines a layout and labeling, as well as how the steps are ordered to produce an intended effect.

### BRIEF DESCRIPTION OF THE DRAWINGS

In the description, for purposes of explanation and not limitation, specific details are set forth, such as particular embodiments, procedures, techniques, etc. to provide a thorough understanding of the present technology. However, it will be apparent to one skilled in the art that the present technology may be practiced in other embodiments that depart from these specific details.

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 presents one embodiment of the SaaS Run-Time Architecture of the Application Platform.

FIG. 2 presents one embodiment of the Application Platform Metadata Model.

FIG. 3 presents one embodiment of a method to create new application services within an existing application system with minimal coding.

FIG. 4 is a schematic diagram of an exemplary computing architecture that can be used to practice aspects of the present technology.

FIG. 5 is a flowchart of an example method of the present disclosure.

FIG. 6 is a flowchart of another example method of the present disclosure.

FIG. 7 illustrates a computer system according to exemplary embodiments of the present technology.

### DETAILED DESCRIPTION

The process of developing, testing, and deploying software applications and services is a labor-intensive process that often involves thousands of lines of code and/or multiple technologies that do not work together. While this disclosure may reference the term “application” it will be understood that such terminology is not limiting and is for example purposes only. The present disclosure is applicable to other similar features such as a service, a bridge, or other similar construct.

This is because today's complex applications encapsulate a wide range of functionality including and not limited to user interface, data management, security, audits, reporting and analytics, integration with other systems, and the ability to customize and tailor behavior to user needs and requirements. Labor intensity means higher overhead costs and longer wait times on development, testing and deployment of new applications.

This is most evident in software services delivered at an enterprise level, which are complex and must be heavily programmed before they can be delivered and utilized by customers and end-users. Also, because each end-user/user or customer (terms used interchangeably herein) has different service requirements, services, or needs, development teams must always try to accommodate each end-user and their customization requests for the enterprise software. Applications are rarely designed in a tailored manner to suit each customer, but instead rely on the development teams to produce fit-all approaches that will work for the largest number of customers and end users.

Customers must also wait on development teams to develop customer requested services. These add-ons to the base service requested by customers are usually lower on these teams' priority list of items, as they focus on ensuring that the base service functions well. Deployment of software is also usually controlled by the development team and relies on their timeframes. Enterprise development teams do not allow customers access to the primary code or logic that runs the service to protect the service or platform from mismanagement, security vulnerabilities and malfunctions. If control or customization is offered to customers, it is usually limited to specific aspects of the service, such as user interface, use configurations, and options.

Enterprise software applications are generally built directly using lower-level development languages, such as Java, or they build applications in a hybrid model that utilize lower-level languages in combination with low-code application platforms (LCAP). However, these approaches face the time and efficiency limitations on relying on these teams to provide new or modify existing services in the enterprise platform. Once these development teams deploy a service, new features and capabilities must be added-on as side systems created separately, sometimes using different architectures, languages, and systems, adding complexity to the system as well as heightened risks of security vulnerabilities. New solutions are needed to provide new services or functionalities without the time and efficiency constraints of today's development environment.

The presented technologies are directed to an enterprise level customer driven service development and integration platform (may be referred to herein as “platform”, “enterprise service” or “service platform”). The platform by default provides several base functionalities and deploys them to customers, but the nature of the platform, its architecture and data model allows the customer to make software changes to alter the functionality and the software of the platform via the platform itself and allows the platform to be extended to allow the customer to build new services or applications to the existing platform with little to no coding. Thus, enabling customization of the platform and deployment of new functionalities and services on a mass scale at the customer level, with each customer able to create, add and maintain the functionalities and services they desire on the base platform. This technology overcomes the time and cost inefficiencies present in current development environments and platforms, by providing a deployable data model that is highly configurable, automatically secure and easy to use, and may be modified to provide specific and custom uses for each customer.

The presented technologies allow the creation of new services as well as the integration of third-party services into the existing service platform via the platform itself and the service and application creation and integration tools the platform provides. The data model used throughout the various services that run as part of, or with the service platform are based on the same variables, definitions and data objects. Any new services created by the customer will require less processing and memory to run and execute since they run as part of the service platform; an improved situation over current enterprise software models that do not work with third party services or are unable to provide new services without extensive development and programming by the developers. The traditional enterprise software model forces the customer or end-user to make use of external third-party software running separately as different applications to provide additional desired functionalities. In this traditional model, because many applications are run to provide the various services required by a customer, larger amounts of computing power are needed including a larger amount of memory usage, processing power, as well as a higher number of concurrent threads to run the various applications. In the customer driven service platform model presented herein where new services are created by and run on the same platform, providing new functions and/or integrated using the available toolsets, the amount of computing power, memory and processing required to run the same number of services is reduced, improving network, storage and computing device performance.

In many embodiments, the platform includes a toolset that encapsulates all the functionality required for running an application, spanning data management, business logic, analytics, integration, security, customization, change management and user experience. This allows customers to modify the platform, its features, capabilities, and behaviors from the customer end, without affecting the platform's key functionalities. This is made possible because the toolset applies key functions (including but not limited to security rules, authentication, user experience and analytics) consistently across all applications and services, allowing customers to customize and alter selected functionalities most pertinent to the customer without having to code.

In various embodiments, the development and integration platform can combine transaction processing and analytics into a unified development platform, which utilizes a single set of metadata based tools, tables, fields and definitions that are consistent across the enterprise application. This definitional unified metadata-based platform supports analytics and transaction processing, with a robust engine that eliminates silos of code and data, allowing application and services development by providing and combining definitions. In some embodiments these metadata are defined and stored in various relational tables or relational metadata objects which provide the basis for the functioning of the platform.

Several embodiments of the proposed development platform include two key concepts or definitions, the meaningful data object, and the way the meaningful data object is used to perform actions in the application, both concepts are defined by the developer. The meaningful data object may be a service that is delivered to the customer, a function that executes specific actions, or even a completely new application. The first concept, the meaningful data object, encapsulates what data is handled, how it is secured, what changes have been made by customers, and the business logic that determines what should happen based on what an organization does with it. Information pertaining to how data is handled may be generally referred to as data handling parameters.

The meaningful data object is defined and includes the following definitions: the elements in the meaningful data object, its taxonomy and structure, how it is related to other data objects, how sensitive the data is (for example, each defined sensitivity level comes with its own security, encryption and handling rules), how the data is validated, what actions can be performed to the data object, and any customer modifications to the data object which includes but is not limited to: any new elements, defaulting values, hidden unused elements, and new validation rules —just to name a few.

The second key concept is the definition of the ways the meaningful data object is used to perform actions in the application. This definition includes the user experience, form factors, reporting and analytics performed, how it fits into an approval workflow, and how it is interfaced to other systems. This allows the meaningful data object to be uniform and be used consistently without having to write new code, or develop application specific logic for user experience across all form factors (desktop, mobile, assistive technologies), query and reporting within applications, presentation of analytics and dashboards related to application data, how data is integrated both into and out of the application (using a number of technologies including but not limited to XML/Soap, JSON, CSV and other integration protocols), and rules to simultaneously process large volumes of data.

In some embodiments the definitions of the meaningful data object or what it does, as well as fields within data objects may be modified by a customer to produce outcomes that are desired. Small changes in an element or field level may produce minor changes, such as displaying a value or result of a new or different variable. Cumulative changes to the definitions of fields or elements, rules, or default values, could create new or modify existing meaningful data objects to produce a new service or significantly alter one by adding logic to the back-end server or database of the provided software. In various embodiments any new or modified service, must be an extension of a default service base class to be registerable in, and added to the platform.

In various embodiments, data objects and their definitions are generally stored as data or metadata objects, in or as JSON files, data tables, metadata tables, data dictionaries and dictionary tables, as well as other possible forms of data collections such as files and forms (collectively referred to herein as “metadata object” or “metadata objects”). These metadata objects and their definitions may also be stored in databases, servers, or other forms of storage such as cloud or immutable storage systems (collectively referred to herein as “data storage system” or “data storage systems”). Each table or metadata object contains the definitions and fields used along with the metadata necessary to allow one or more functions to occur, change the behavior of the system, or allow a service to execute one or more operations. The definitions may identify how data is managed in the system. These metadata objects may be stored in a database, database server, or one or more data storage systems which provides the data layer for the rest of the platform. A services layer then uses that data and/or metadata from the data layer by calling these definitions to execute various functions and actions. Various provided services may each produce different outcomes. The customer may also create new metadata objects in the data storage systems, or modify existing ones, and store new or existing data objects, incorporate new data objects derived from one or more of the defined data objects provided by the platform, or modify pre-existing data objects in the platform to provide additional functionalities.

In several embodiments, an existing service or application provided by the platform may be extended to provide new characteristics and functions. A customer can access the data stored in the data storage systems through the services layer while allowing the customer to make use of, alter, combine and even delete many data objects and meaningful data objects to create new services and standalone applications, the platform does not allow the customer to access or modify base code or runtime-engine code that could affect the running of the platform, but provides all other data objects including JSON objects, meaningful data objects, services and other tools to the customer allowing them to create new services and applications. For example, if the enterprise software does not have a text message notification feature where customers receive text message notifications from a customer regarding various orders, documents, tasks, or appointments, a customer may add that feature by using predefined fields that are provided by the developers and stored in underlying tables or metadata objects in the data storage systems and/or by creating one or more tables or metadata objects that provide this feature. The customer may add new data objects together, modify existing ones or create new objects from scratch. The customer may then register the new service in a metadata object that contains all the current services that are executable by the platform.

In various embodiments the changes to the functionality of the platform via modifying or creating new underlying tables or metadata objects stored in one or more data storage systems can be carried out through a user interface (UI) that presents the customer with the option to make changes to the platform. This could include a simplistic user interface that incorporates drag and drop features, allowing a customer to drag and drop various fields or data objects to new tables to add new functions or services. The UI may step the end-user through the steps to create fields, or rows or otherwise alter the table or metadata object to add rows, alter values, provide new functions, UI or UX elements. In many embodiments, simple user experience (UX) changes may be made by modifying the existing application without changing its underlying functionality. For example, in an application for school admissions, by modifying the value in specific fields, the customer may change the labels that are displayed. Changes in the value of these fields may also change the position of certain buttons, labels, headings, or presentation of other information. Some fields may be changed along with the type of values they hold, for example a numbers field may change to a text field. These can all be carried out by the customer via a specifically designed UI.

However, the present disclosure can be implemented without employing the use of a user interface, where applications/services are created from a prior instance of another application/service without requiring a user to discretely select features to be included in the new application/service through a user interface. Thus, some systems can be adapted to create derivative applications/services in an automated manner.

Larger changes could be made to create new parts of a service, this could occur by not only changing the fields and values of the provided tables, but also by adding new rows to the table or metadata object, each row containing a new field definition that has its own functionality or purpose. For example, instead of adding a different or new label to a document, a new row may enable the customer to add a whole new tab or section to the document, or even produce a new separate document, order, transaction, or action.

In several embodiments, the framework of the platform is built to allow users to embed new logic, including conditional logic and instructions for new or modified functions, methods, classes or services, into the logic of the platform itself and register that new logic to be invoked as part of the base functionality, and tied to the backend, the runtime engine and base framework of the platform. Each service is registered as metadata, usually in a meta-table or metadata object stored in one or more database storage systems. Only the services that are registered in the metadata may be called by the platform. Each service may have its metadata object and be partially or fully combined with metadata objects to produce larger, more complex services and applications. Upon registration into the platform in a registration table, or registration metadata object, this new code, logic, service or even application created by the customer is integrated with the rest of the application and may be called at any point by the platform. This adds new functionality and ties the new services to the runtime engine without having to change the backend code of the platform. This new functionality, as well as the rest of the platform may then be sandboxed to ensure it does not interfere with any other users' versions of the platform.

The database tables or metadata objects that include all the metadata and definitions relied upon by the platform may include metadata to configure or control a number of functional and interface items including and not limited to: placement and position of data objects, user interface, sections where data appears or is used, conditional functions, how to handle JSON objects, where and how to map data, whether a module is static or dynamic, how to bind modules together or to other data objects, expressions used to validate data or inputs, appearance of text, where data is pulled from to be used in functions or in other fields, override functions and displays, error handling, time handling, classes, methods, objects invoked, settings to determine whether the service is internal or open to external endpoints, service identifiers, conversion to and from JSON objects, as well as conversion functions between different programming languages and data types.

In several embodiments, where new services are added to the base platform, these services are executed by first pulling default metadata from tables or metadata objects in the database to run the services and initialize them as a service, based on the number of times the new service has been registered it may run as one or more instances. So, for example if a specific service is created and registered twice in the registration table or registration metadata object, with one row in the table or metadata object (one registration) is tied to a telephony service and the other row or registration is tied to a third-party email service, the service will execute and create two instances, one for each version of the new service/function. Separate keys and variables may be used for each service based on user inputs. These new services must extend a base service to ensure security and validity of the service when executed, otherwise the new service would not run. Extending the base service class ensures the maintenance of security, authentication, encryption, and log-in features of the platform.

In various embodiments, the platform may allow integration with third party software such as Twilio, Sendgrid or Oracle PeopleSoft to utilize third-party services. In many embodiments, integration tools may have to be built or coded to allow use of third-party services. Integration tools may include wrapper code, which may, as an exemplary embodiment, be written, designed or configured for third party SDKs (Software Development Kits) or APIs, error handling, filtering, and mapping. In some embodiments, services from other third-party applications may be incorporated with metadata, functions or services in the base platform to provide new functionalities suitable to a customer's needs. This may include combining third-party software with the tools provided by the platform including definitions, fields, functions, methods and classes and other data objects.

To integrate software, an integration table or integration metadata object in the data storage systems may be used. The integration metadata object includes the name of the service, references the service API(s) and includes an encrypted JSON object that contains any keys necessary for the end-user to run the service. This encrypted JSON folder is unpacked and run by the platform and must include all necessary data objects and keys to be executed on the platform. Because these metadata objects, and the data objects within them are modifiable, if a customer already has access to a third-party service and does not wish to purchase or subscribe to the third-party service through the platform, the customer may use their own key values providing their credentials in the encrypted JSON object, replacing the default keys that would otherwise be provided by the platform. This third-party service or account is then integrated to the platform via the customer's own account and must be registered as a service to be called anywhere in the platform. While keys have been described, it will be understood that any authentication protocol can be used. Thus, any authentication element can be used, such as a username/password, token or similar data object.

A third-party service may also be set up to only be integrated with or functional within only a section of the platform. For example, the customer may add or create a new directory service allowing users to search for specific people and their phone numbers through a new user interface, the end-user may customize this service to be integrated with a third-party application such as Twilio. Integrating this platform service with Twilio would allow the customer to search individuals and then send them a text message using Twilio provided services. However, this integration may only be limited to this one user interface that the customer has designed, and other pages or documents within the service and platform may not make use of or be integrated with Twilio. This integration may also be completely independent from the original service or application. The customer may also add multiple other third-party services to this specific interface, for example integrating SendGrid to also allow sending emails to the individuals found in the directory service the customer has built. Third-party applications may be integrated with separate services within the platform, or with the whole platform.

In various embodiments, integration adapters can be built for each third-party service, these adapters may include wrapper code used for error handling and integration of third-party services with the platform. This wrapper code, where in some exemplary embodiments is written, designed or configured for third party SDKs (Software Development Kits) or APIs, is usually developed by the platform developers and provided as definitional data objects that a customer or end-user may utilize to integrate third party services they desire. In other embodiments, integration is more complex, and requires writing procedural code to carry out translations from one value to another, conversion of types of values, filtering and mapping which may have to run before initializing the third-party services.

The tables, or metadata objects and the data storage systems used for these customizations may be presented in a user-friendly UI or may be accessed programmatically, based on the skill level and preference of the customer. Various fields and functions are listed in the table rows in the database, many of which include JSON objects that map keys and variables to values that are used to produce difference functions and outcomes. In some instances, a function is too complex or may contain various other functions, and therefore a row would not contain variable-value pairs but contain a reference to another function, which could be in the same or another metadata object in the data storage systems. In some embodiments, the function may even be an integrated third-party application. Database objects may also have one or more of the following: an identification number, a service name, a JSON path, instructions sent to execute other logic and make function calls in the backend of the platform, and field definitions that carry out certain actions to data objects and key value pairs such as pruning, inserting, deleting, and modifying values.

While the present technology is susceptible of embodiment in many different forms, there is shown in the drawings and will herein be described in detail several specific embodiments with the understanding that the present disclosure is to be considered as an exemplification of the principles of the present technology and is not intended to limit the technology to the embodiments illustrated.

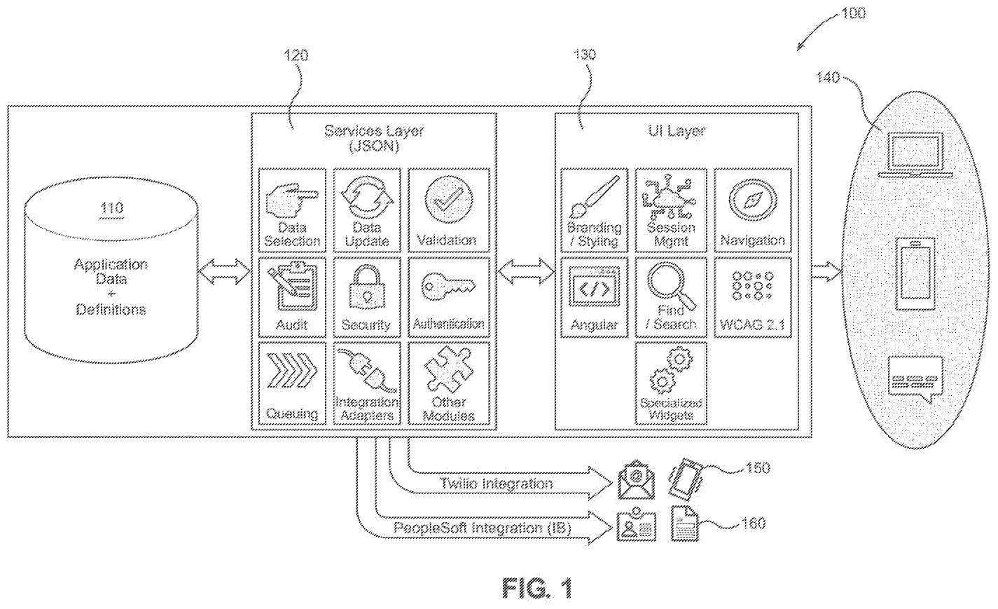

FIG. 1 presents one embodiment of the SaaS Run-Time Architecture 100 of the Application Platform. Application data and definitions, including metadata and metadata objects are in are stored in a data storage system 110. A services layer 120 which includes several default services, as well as any customer-built or modified services, pulls metadata, JSON and other data objects, and calls functions and instructions from the metadata objects in data storage system 110 which contains application metadata and definitions. The services layer 120 may include several default services that are provided with the base version of the platform including, data selection, data updates, validation, auditing, security, authentication, queuing, integration adapters that are used to integrate third-party applications with the platform, and other modules. The services layer 120 also connects to a UI layer 130 which is also customizable by the customer, and by default provides the ability for branding or styling the services, managing sessions, navigation, Angular or AngularJS, handling searches, specialized widgets, and accessibility guidelines. The UI layer 130 may be displayed on customer devices 140 which may include any type of computing device, smartphones, tablets, and the like. The platform may also come with pre-built integration adapters such as Twilio integration adapter 150 and PeopleSoft integration adapter 160 allowing customers to integrate services from these third-party applications out of the box. Other integration adapters may be built and added to the services layer 120.

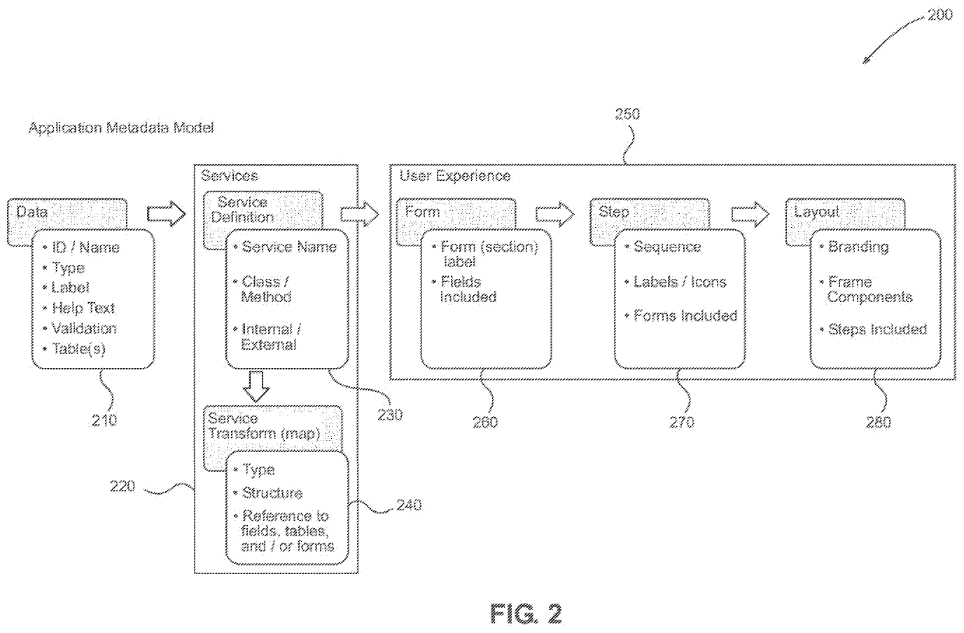

FIG. 2 presents one embodiment of the Application Platform Metadata Model 200. The metamodel data includes information such as identification or name of data objects, the type of data objects, the labels for each data object, any help text associated with data objects, validation data, as well as metadata objects in the data storage system which can also store the other objects. The services layer 220 includes service definitions 230 that are built from the metadata obtained from the database. The service definitions provide the service name and include the classes and methods that a service may invoke as well as any rules regarding whether the service is internal or may be accessed externally. The services layer 220 also contains service transformation and mapping component 240, which utilizes the service definitions 230 to produce a new or altered service, program, or application by the transformation and mapping of the service definitions data by adding, copying, replicating, deleting fields and other data, converting data from one type to another, moving, combining, reformatting, adding references to data objects, tables, forms, and metadata objects altering data structures and renaming data, in addition to other transformation and mapping methods.

The services layer 220 is consumed by the customer in a format determined and delivered by the user experience and interface layer 250, which takes the instructions from the services layer 220 and transforms them into a UX and UI to execute and deliver the services. The user experience and interface layer 250 contains a form component 260 which determines how forms displayed to the user are labeled, and what data fields they include. The user experience and interface layer 250 also contains a step component 270 which may be made up of multiple forms created at the form component stage. The step component 270 may determine the order by which included forms, and other data objects are displayed to the user, as well as any labels or icons displayed. The layout component 280 includes the one or more steps to be displayed and determines their layout, labeling as well as how the steps are ordered to produce the intended effect.

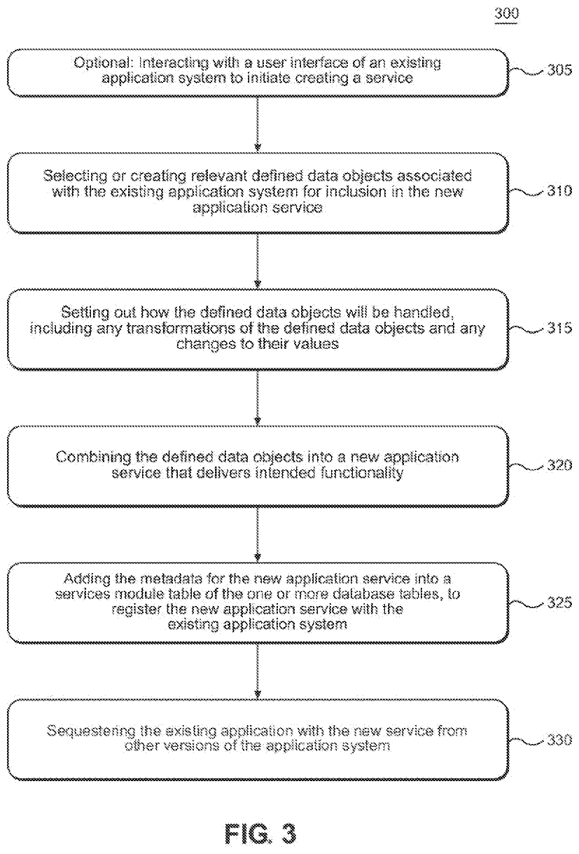

FIG. 3 presents one embodiment of a method to create new application services within an existing application system or platform with minimal coding. In various embodiments, optionally a user must first interact 305 with the provided UI in the existing platform, the user may select from a number of options, one of which is to create a new service; other options may be provided to the user including and not limited to creating new variables, fields, tables, functions, methods, classes or modifying any of these. The user must then select or create 310 the data objects or components that will make up or be part of the service, which may be stored in one or more data storage systems such as databases, servers, or an immutable data storage. The data objects may be simple variables such as defined data objects and fields, or they may be more complex functions, methods, classes or even services made up of other data objects. The user in many embodiments may also create new data objects from already present ones in the existing platform or application system. The user may also select from these created data objects. The user then sets out 315 how the selected data objects will be handled in the application or service, this includes being transformed or mapped when the new service is executed, in many embodiments, this is done by creating, selecting, rearranging and/or combining a number of data objects in the application system. Transformations may include but are not limited to adding, copying, replicating, deleting fields and other data, converting data from one type to another, moving, combining, reformatting, adding references to data objects, tables, forms, and metadata objects altering data structures, and renaming data. That is, data objects can be transformed or mapped from the database when used for the new service.

In various embodiments, the defined data objects, are combined 320 and/or arranged in specific orders to produce an intended result or effect to deliver intended functions of the new service. For the new service to be functional as part of the existing application or platform, the service must be registered with the platform. The metadata of the new service is added 325 to a services module table or services module metadata object, which contains the metadata of all executable services by the platform, to register the service with the existing platform allowing it to be executed. Finally, in some embodiments, the new service and/or the existing platform are sequestered from any other versions of the platform that may be associated with other users. This ensures that the changes made by a customer are limited to that one customer, without affecting the base platform and other versions of the platform.

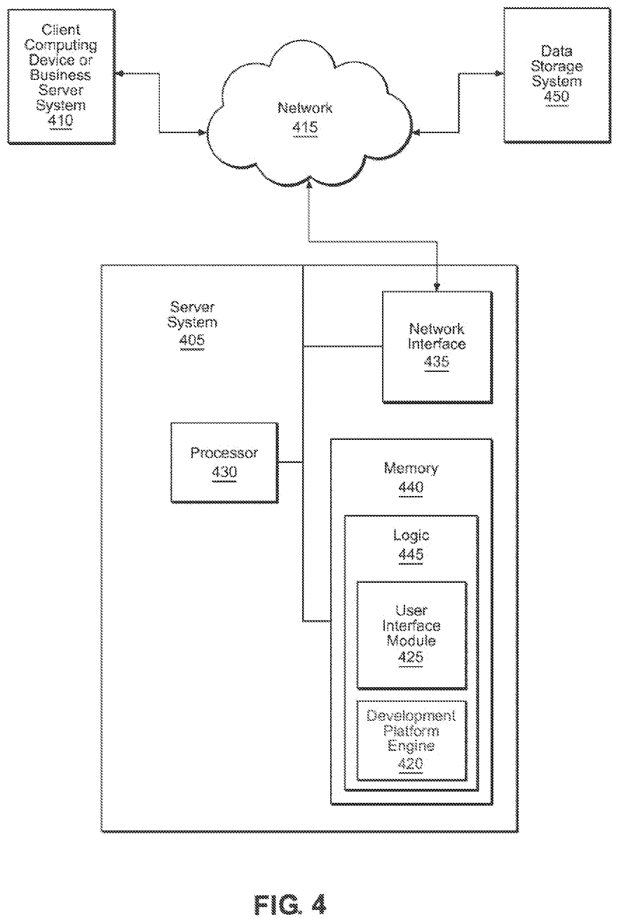

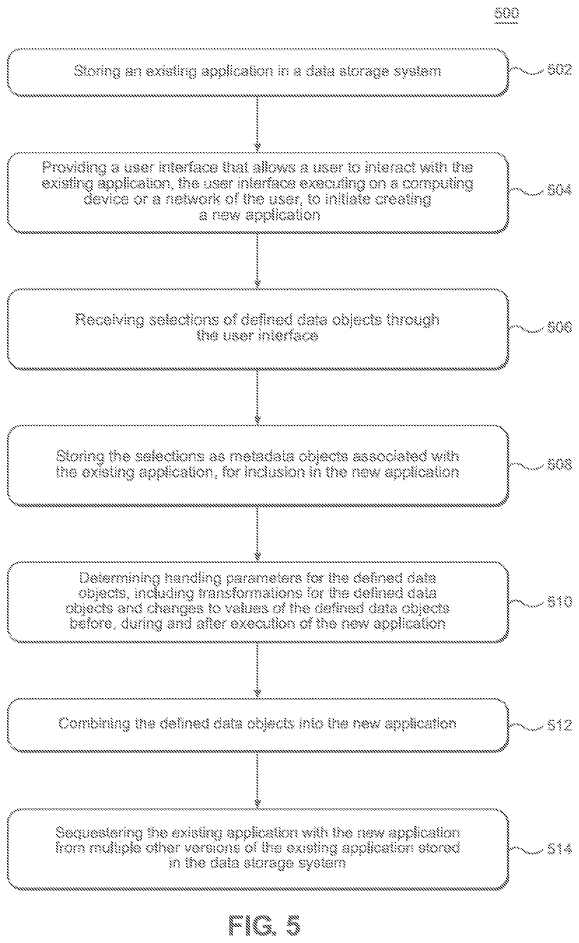

FIG. 4 is a schematic diagram of an exemplary computing architecture that can be used to practice aspects of the present technology. The architecture comprises a server system, hereinafter “system 405” that is configured to provide server system functionalities. Generally, the system 405 is configured to communicate with client computing devices, such as a client computing device or business server system 410, or data storage system 450. An example of a computing device that can be utilized in accordance with the present technology is described in greater detail in FIG. 5.

The system 405 may communicatively couple with the client computing device or business server system 410 via a public or private network, such as network 415. The system 405 may also couple with a data storage system 450 which may be the location where the metadata tables and metadata objects of the platform are stored.

Network 415 may include any type of suitable networks, which may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 415 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The system 405 generally comprises a processor, 430, a network interface 435, and a memory 440. According to some embodiments, the memory 440 comprises logic (e.g., instructions) 445 that can be executed by the processor 430 to perform various methods. For example, the logic may include an optional user interface module 425 as well as the platform engine 420 which may include any of the platform's data object definitions and configurations, the runtime engine, system-to-system mapping instructions and functionality, automated user interface rules, as well as any of the definitions, data structures, architectures, rules and logic that are configured to provide the functionalities of the development platform.

It will be understood that the functionalities described herein, which are attributed to the system 405 and platform engine 420 may also be executed within the client computing device or business server system 410. That is, the client computing device or business server system 410 may be programmed to execute the functionalities described herein. In other instances, the system 405 and client computing device or business server system 410 may cooperate to provide the functionalities described herein, such that the client computing device or business server system 410 is provided with a client-side application that interacts with the system 405 such that the system 405 and client computing device or business server system 410 operate in a client/server relationship. In some embodiments, complex computational features may be executed by the system 405, while simple operations that require fewer computational resources may be executed by the client computing device or business server system 410, such as data gathering and data display.

FIG. 5 is a method of the present disclosure. The method can include a step 502 of storing an existing application in a data storage system. This can include storing a previously generated version of an application. This version can include a version created by another author or a collection of application features/functions used across a plurality of other applications and/or users.

Next, the method includes a step 504 of providing a user interface that allows a user to interact with the existing application. For example, the user can utilize elements of a design UI to add, change, modify, delete, or otherwise interact with elements of the existing application. In one example, the existing application is a webform used on a website. An existing webform can be presented to the user in such a way that the user can drag and drop existing elements of the UI to change the layout or presentation of the webform elements. The UI can also include selectable features that allow the user to change colors, backgrounds, and other design elements. The number of items and features that can be presented to the user are not limited, as would be known to one of ordinary skill in the art with the present disclosure before them. The UI can execute on a computing device or a network of the user, allowing the user to initiate the creation of a new application. In general, values of each defined data object affect an appearance or function of the new application.

Next, the method includes a step 506 of receiving selections of defined data objects through the user interface. This can include receiving the selections from the user through the UI where specific data objects stored in the data store can be identified for incorporation into a new application.

In step 508, the method can include storing the selections as metadata objects associated with the existing application, for inclusion in the new application. The method can also include a step 510 of determining handling parameters for the defined data objects, including transformations for the defined data objects and changes to values of the defined data objects before, during and after execution of the new application. Handling parameters define how particular functionalities behave. That is, the handling parameters are more granular input to a defined data object.

Finally, the method includes a step 512 of combining the defined data objects into the new application. The user can then execute and use the new application created from part or all of the existing application. The user can use more or fewer defined data objects included in the existing application to create the new application.

The method can include a step 514 of sequestering the existing application with the new application from multiple other versions of the existing application stored in the data storage system.

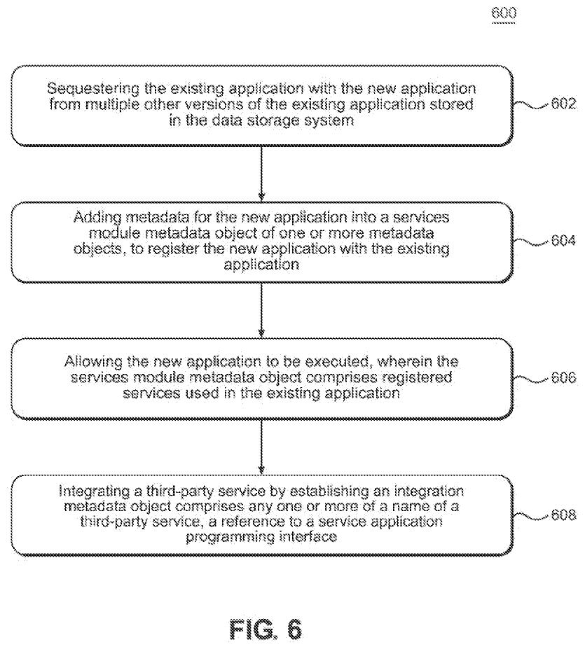

FIG. 6 includes a flowchart that includes steps related to the method of FIG. 5. The method can include a step 602 of sequestering the existing application with the new application from multiple other versions of the existing application stored in the data storage system. Sequestering can include blocking access to the existing application to prevent confusion or unintended use or modification of the existing application by the user.

The method can include a step 604 of adding metadata for the new application into a services module metadata object of one or more metadata objects, to register the new application with the existing application. In some embodiments, the method includes a step 606 of allowing the new application to be executed, wherein the services module metadata object comprises registered services used in the existing application.

In some embodiments, the method can include a step 608 of integrating a third-party service by establishing an integration metadata object comprises any one or more of a name of a third-party service, a reference to a service application programming interface. It will be understood that the integration metadata object further includes an encrypted object that includes one or more keys for the user to run the third-party service.

Also, in some embodiments, the defined data objects of the new application are stored as rows in a table, where each row comprises a new field definition that has a unique functionality or purpose. In some instances, each of the defined data objects comprises data objects, taxonomy and structure, relationships to other data objects, sensitivity of the data objects, data objects validation, and/or data objects actions.

According to some embodiments, the defined data objects each comprises customer modifications to the data objects which include any one or more of: new elements, defaulting values, hidden unused elements, and/or new validation rules.

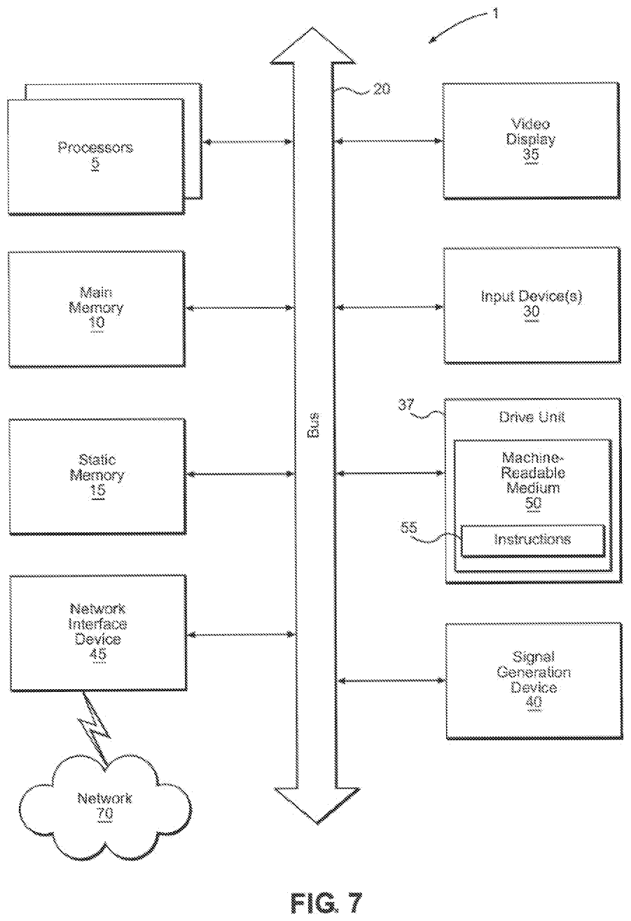

FIG. 7 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The components provided in the computer system 1 are those typically found in computer systems that may be suitable for use with embodiments of the present disclosure and are intended to represent a broad category of such computer components that are known in the art. Thus, the computer system 1 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network 70 via the network interface device 45 utilizing any one of several well-known transfer protocols (e.g., Hyper Text Transfer Protocol (HTTP)). While the machine-readable medium 50 is shown in an example embodiment to be a single medium, the term “computer-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the embodiments of the disclosure as described herein.

The computer program instructions may also be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter.

The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents. In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the invention in the form disclosed. Many modifications and variations will be apparent to those of ordinary skill in the art without departing from the scope and spirit of the invention. Exemplary embodiments were chosen and described to best explain the principles of the present technology and its practical application, and to enable others of ordinary skill in the art to understand the invention for various embodiments with various modifications as are suited to the particular use contemplated.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel or may be performed at different times.

The various embodiments described above, are presented as examples only, and not as a limitation. The descriptions are not intended to limit the scope of the present technology to the forms set forth herein. To the contrary, the present descriptions are intended to cover such alternatives, modifications, and equivalents as may be included within the spirit and scope of the present technology as appreciated by one of ordinary skill in the art. Thus, the breadth and scope of a preferred embodiment should not be limited by any of the above-described exemplary embodiments.

What is claimed is:

1. A method comprising:
storing an existing application in a data storage system;
providing a user interface that allows a user to interact with the existing application, the user interface executing on a computing device or a network of the user, to initiate creating a new application;
receiving selections of defined data objects through the user interface;
storing the selections as metadata objects associated with the existing application, for inclusion in the new application;
determining handling parameters for the defined data objects, including transformations for the defined data objects and changes to values of the defined data objects before, during and after execution of the new application; and
combining the defined data objects into the new application.

2. The method according to claim 1, wherein the existing application is associated with a different user.

3. The method according to claim 1, wherein values of each defined data object affect an appearance or function of the new application.

4. The method according to claim 1, further comprising sequestering the existing application with the new application from multiple other versions of the existing application stored in the data storage system.

5. The method according to claim 1, further comprising adding metadata for the new application into a services module metadata object of one or more metadata objects, to register the new application with the existing application.

6. The method according to claim 5, further comprising allowing the new application to be executed, wherein the services module metadata object comprises registered services used in the existing application.

7. The method according to claim 1, further comprising integrating a third-party service by establishing an integration metadata object comprises any one or more of a name of a third-party service, a reference to a service application programming interface.

8. The method according to claim 7, wherein the integration metadata object further includes an encrypted object that includes one or more keys for the user to run the third-party service.

9. The method according to claim 1, wherein the defined data objects of the new application are stored as rows in a table, where each row comprises a new field definition that has a unique functionality or purpose.

10. The method according to claim 9, wherein each of the defined data objects comprises data objects, taxonomy and structure, relationships to other data objects, sensitivity of the data objects, data objects validation, and/or data objects actions.

11. The method according to claim 9, wherein the defined data objects each comprises customer modifications to the data objects which include any one or more of: new elements, defaulting values, hidden unused elements, and/or new validation rules.

12. A system that utilizes at least one process and memory to provide a computer implemented method, the system comprising:
a data storage system for storing metadata for data objects of an existing application;
a services layer comprising service definitions the metadata obtained from the data storage system;
a service transformation and mapping component that utilizes the service definitions to produce a new or altered service, program, or application by transformation and mapping of the service definitions;
a user experience and interface layer that transforms instructions from the services layer into a user interface, the user experience and interface layer comprising:
a form layer that determines how forms displayed to the user are labeled, and what data fields are included in the forms;
a step component that obtains multiple forms from the form layer and determines an order by which the multiple forms, and other data objects are displayed to the user, as well as any labels or icons displayed; and
a layout component that defines how the multiple forms are displayed and determines a layout and labeling, as well as how the steps are ordered to produce an intended effect.

13. The system according to claim 12, wherein the service definitions comprise a service name, classes and methods invoked, and rules regarding whether the new or altered service, program, or application is internal or accessible externally.

14. The system according to claim 13, wherein the user experience and interface layer comprises:
a form layer that determines how forms displayed to the user are labeled, and what data fields are included in the forms;
a step component that obtains multiple forms from the form layer and determines an order by which the forms, and other data objects are displayed to the user, as well as any labels or icons displayed; and
a layout component that defines how the forms are displayed and determines a layout and labeling, as well as how the steps are ordered to produce an intended effect.

15. The system according to claim 14, wherein the existing application is associated with a different user, and wherein the values of each defined data object affect an appearance or function of the new or altered service, program, or application.

16. The system according to claim 14, wherein the system is configured to sequester the new application from multiple other versions of the existing application stored in the data storage system and metadata is added for the new or altered service, program, or application into a services module metadata object of the one or more metadata objects, to register the new or altered service, program, or application with the existing application.

17. A method comprising:
providing a user interface that allows a user to select or create defined data objects that comprise a new service for an existing platform, each of the data objects being stored in a database;
receiving handling parameters for the defined data objects, wherein one or more of the defined data objects are transformed or mapped from the data storage system when used for the new service;
arranging the defined data objects so as to produce an intended result or effect, or to deliver an intended function of the new service;
adding metadata for the new service to a services module table or services module metadata object to register the new service with the existing platform; and
allowing the user to execute the new service in the existing platform.

18. The method according to claim 17, further comprising integrating a third-party service by establishing an integration metadata object comprises any one or more of a name of a third-party service, a reference to a service application programming interface.

19. The method according to claim 18, wherein the integration metadata object further includes an encrypted object that includes one or more authentication elements for the user to run the third-party service.

20. The method according to claim 17, further comprising sequestering the new application from multiple other versions of the existing application stored in the data storage system.
